(19) United States
(12) Patent Application Publication
(10) Pub. No.: US 2014/0330576 A1
(43) Pub. Date: Nov. 6, 2014

(54) Mobile Platform Designed For Hosting Brain Rehabilitation Therapy And Cognitive Enhancement Sessions

(71) Applicant: James Dean Bauer, Lebanon, OR (US)

(72) Inventor: James Dean Bauer, Lebanon, OR (US)

(21) Appl. No.: 14/268,222

(22) Filed: May 2, 2014

Related U.S. Application Data
(60) Provisional application No. 61/818,545, filed on May 2, 2013.

(51) Int. Cl. G06F 19/00

(52) U.S. Cl. CPC G06F 19/3418
USPC 705/2

(57) ABSTRACT

A mobile platform allows trainers to host online brain rehabilitation and cognitive enhancement sessions with clients. The sessions can be individually tailored or chosen from a plethora of prepared sessions. The trainer/evaluator uses real time questionnaires to evaluate the status of the patient prior to preparing the training session. They can also view the results and performance of the patient in real time or at any time after the session has been completed. The mobile platform is designed to facilitate the creation and growth of a community of users by facilitating communication and interactivity between the users upon the satisfactory completion of a battery of tests and evaluations. The mobile platform serves as an information resource for trainers and clients by incorporating a set of algorithms, rules, and guidelines regarding the administration of brain rehabilitation and cognitive enhancement sessions. This aids both trainers and clients participating in the sessions.

### CLAIM FOR DOMESTIC PRIORITY

This application claims the benefit of pending U.S. Provisional Patent Application No. 61/818,545 filed May 2, 2013 and under 35 U.S.C. §120 claims the benefit thereof.

### FIELD OF THE INVENTION

The present invention relates generally to cognitive therapy and enhancement. More specifically, the present invention is a mobile platform adapted for hosting individually, professionally tailored brain rehabilitative therapy and cognitive enhancement sessions (professionally monitored in progress as well as adapted for the possible involvement in further treatments sessions with an online community of other patients (the user community) that have met proficiency and psychological selection criteria.

### BACKGROUND OF THE INVENTION

Brain rehabilitation is an integral step in the recovery process following a brain injury. In addition to severe blows to the head, brain dysfunction is also brought upon by factors such as strokes, brain aneurysms, and brain tumors. These brain related conditions often result in lingering consequences relating to emotions, thinking, memory, and movement, among others. The aforementioned problems hinder and complicate a person's return to normal life, work, and/or school.

Brain rehabilitation typically begins following a diagnosis of the patient in order to determine his or her individual needs as well as appropriate treatment methods. The rehabilitation process generally encompasses administration of prescribed medication as well as physical and mental exercises designed to facilitate the patient's transition back to their normal life. These generally have to be performed under the eye of an evaluator or trainer, and thus require the patient to attend specific appointments. This is often hard because the person is after all, brain injured. Their life and its scheduling is not running at its optimal efficiency and missed appointments are the norm. What is needed from the patient's perspective is a system wherein the patient can participate from home, can influence his ongoing scheduling, and session content, can perform additional sessions on his own, and has all of his session feedback recorded and professionally evaluated. What is needed from a professional trainer/evaluator's position is to get the patient to complete the entire series of training sessions according to a schedule that best suits that patient, and are based on that patient's reported current situation. Equally important is for the trainer/evaluator to be able to monitor that patient's progress either in real time or after a session's completion, and to be able to get that patient into a less professionally attentive “community group” of other similarly situated patients. The eventual goal is to get the patients to successfully complete rehabilitation and be cleared for independent living, wherein long term and follow up care can replace the supported environment used during the rehabilitation and treatment.

Henceforth, what would be a major improvement in current brain trauma rehabilitation, would be a system of cognitive therapy and enhancement sessions for brain injured individuals that can be remotely scheduled, remotely billed, remotely tailored to that patient with real time input from the patients, remotely monitored in real time or after a session has been completed, and can lead to the potential inclusion of that patient into a cognitive work group with a low level of ongoing professional medical involvement.

### SUMMARY OF THE INVENTION

Cognitive enhancement is often incorporated into rehabilitative therapy following a brain injury, in order to restore patient learning, reasoning, problem solving, decision making, and communication skills. However, the benefits of cognitive enhancement extend beyond neurological patients and are commonly used as a means of accelerating learning.

The present invention is a mobile platform that allows trainers to host brain rehabilitation and cognitive enhancement sessions to be undertaken by patients. The goal is to allow this to be done on a schedule that accommodates both the trainers and the patients and that is not hamstrung by the necessity to physically meet at a medical facility. Equally important is the goal of minimizing the amount of professional medical assistance that is needed while maximizing the amount of treatment that the patients receive. A final goal is to be able to establish the patient in a continuing “mobile social community” of other brain injured patients, working together to better themselves and others of their group. The mobile platform facilitates the formulation and growth of a community of users. The present invention allows a trainer to remotely connect to and interact with patients for rehabilitative therapy and cognitive enhancement sessions. The remote connections are established through virtually any medium including, but not limited to, Wi-Fi, Asymmetric Digital Subscriber Line (ADSL), Fiber connectivity, 3G, 4G, LTE, dialup, and all other future communication channels. Additionally, patients may interact with one another for the purposes of the sessions as well. The mobile platform comprises a cloud and a logistical back office. The cloud serves as a repository for session exercises/plans and corresponding downloadable software packages/applications as well as patient data. Software packages corresponding to session exercises/plans are downloaded directly from the cloud for use during sessions. Sessions are conducted through patient and trainer graphical user interfaces (GUI) based on end user devices such as tablet computers. The GUIs allow patients and trainers to communicate through both audio/video (A/V) channels. Touch screen interaction as well as haptic feedback may be incorporated into the sessions if available.

The present invention allows trainers to develop session plans on an individual patient basis. This is particularly important as each patient likely requires a specialized rehabilitation or enhancement program based on his or her unique needs, something made difficult by the widely varying needs among patients. Real time questionnaires provide a plethora of information for the trainers to use when formulating this. Trainers may easily access cloud-based patient information prior to formulating individualized session plans. Patient performance analysis is stored on the cloud as well following a session. The back office handles the logistics regarding scheduling, billing, and user information technology (IT) support. In addition, the present invention may integrate third party applications to maintain automated back office logistics.

The present invention facilitates communication and interactivity between users in order to create and grow a community of users. The present invention seeks to improve and optimize brain rehabilitation and cognitive enhancement by placing amongst multiple patients. Developmental exercises delivered by a human trainer/coach are far superior to exercises delivered through a computer algorithm as human trainers/coaches are able to address patient concerns and needs on a more personal level. The mobile platform serves as a medium for delivering personal brain rehabilitation and cognitive enhancement exercises from healthcare personnel to patients. By developing an on line community network of brain injured patients, qualified as trainers, that can continue to work together, the patients can continue to improve without the time constraints of scheduled medical appointments and eliminate or minimize the need for expensive medical rehabilitation.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below. It should be noted that “client” and “patient” are used interchangeably herein, as are “trainer” and “evaluator.”

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

### BRIEF DESCRIPTION OF THE DRAWINGS

FIG. 1 is a diagram illustrating the various components of the BRMP system of the present invention;

FIG. 2 is an exemplary computing device of the present invention;

FIG. 3 is a flowchart illustrating the steps of the BRPM system;

FIG. 4 is an illustration of an example session exercise;

FIG. 5 is a diagram of a trainer's point of view while hosting a session with multiple patients;

FIG. 6 is an exemplary patient/patient screen layout for a cognitive exercise of the present invention;

FIG. 7 is an exemplary trainer screen layout of the present invention;

FIG. 8 is an exemplary screen layout illustrating a second cognitive exercise of present invention in progress;

FIG. 9 is an exemplary patient screen layout illustrating a community training group and the avatar's associated with individual patients in that community training group;

FIG. 10 is an exemplary patient welcome screen layout of the present inventing; and

FIG. 11 is an exemplary screen layout illustrating a self-assessment module for patients to self-asset various factors influencing a his/her current situation.

### DETAILED DESCRIPTION

The embodiments described herein may be practiced with various computer system configurations including retrofit devices, microprocessor systems, programmable consumer electronics, mainframe computers, and distributed network-computing environments. The embodiments described herein also employ various computer-implemented operations to data stored in various computer systems and can be specifically configured to perform these operations.

The present invention is computer implemented and generally is an online network distributed service, platform, or website (generally said to be operated from and stored on a remote server referred to as “cloud”) that provides the functionality described herein, and may comprise any combination of the following: computer hardware, computer firmware, and computer software. Additionally, for purposes of describing and claiming the present invention as used herein the term “application” and/or “program” refers to a mechanism that provides the functionality described herein and also may comprise any combination of the following: computer hardware, computer firmware, and computer software.

The present invention is a mobile platform designed for hosting brain rehabilitative therapy and cognitive enhancement sessions (brain rehabilitation mobile platform or “BRMP”.) The BRMP system 10 comprises a set of software packages and hardware components that have three distinct functions: managing the administrative aspects associated with operating the brain rehabilitation sessions (the “back office”); the brain rehabilitation sessions; and the community formation. The elements of the BRMP that accomplish this, involve the personal mobile computing devices used by the trainer and the patient, the network accessible servers/databases that store the user data, as well as the ability for distributed computing over a network, to run the system's programs/applications and access the system's databases via many connected computers simultaneously.

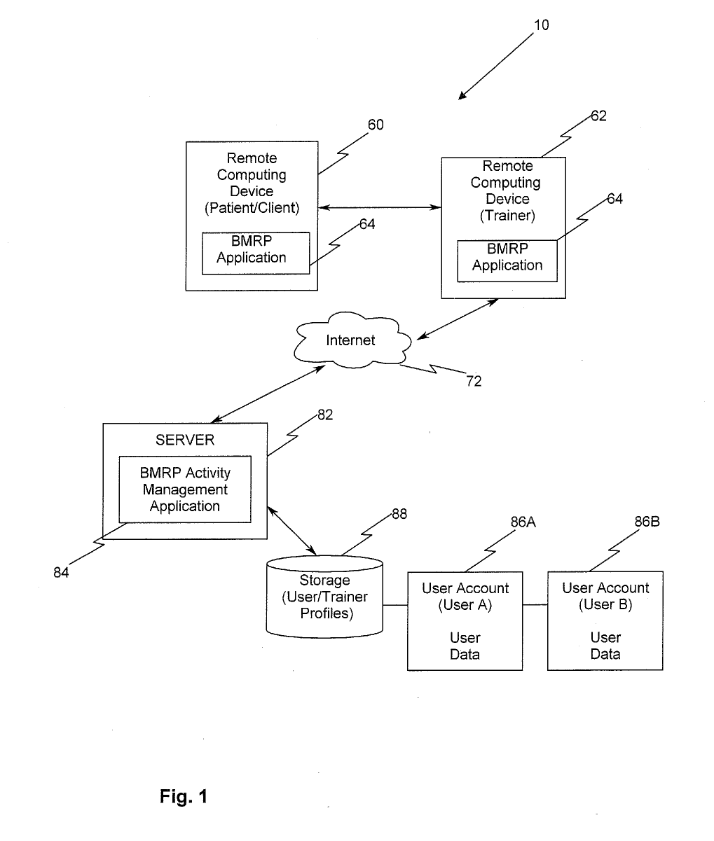

FIG. 1 is an exemplary environment illustrating BRMP system 10 of the present invention. For simplicity only two remote computing devices are illustrated, remote computing devices 60 and second remote computing device 62. Remote computing devices 60, 62 can be any computing device: e.g., laptop, desktop, tablet, smartphone, or an computing device capable of wired or wireless communication with the internet 72. As illustrated remote computing device 60 is the patient accessed computing device, while second remote computing device 62 illustrates the trainer accessed computing device. Remote computing devices 60, 62 are capable of wireless (or wired) communication with the Internet 72. Installed on remote computing device 62 is BRMP application 64, which may be downloaded from server 82. Once application 64 has been installed on remote computing device 60, 62, the computing devices can be configured to communicate with each other forming their own “community” for BRMP sessions.

Server 82 can include a number of applications related to or servicing/management of the BRMP system 10 and the associated users of BRMP system 10 via user accounts. Two exemplary accounts, user account (User A) 86A and user account 86B are shown. BRMP management application 84 includes logic for providing access to various user accounts 86A, 86B, as well as “back office” functionality such as billing, scheduling, and general system support. Server 82 can include storage 88 for storing session exercises as well the user profile data associated with user accounts such as medical information, sociological data, and performance ratings and analysis data. It may be stored as raw data or in a relational database.

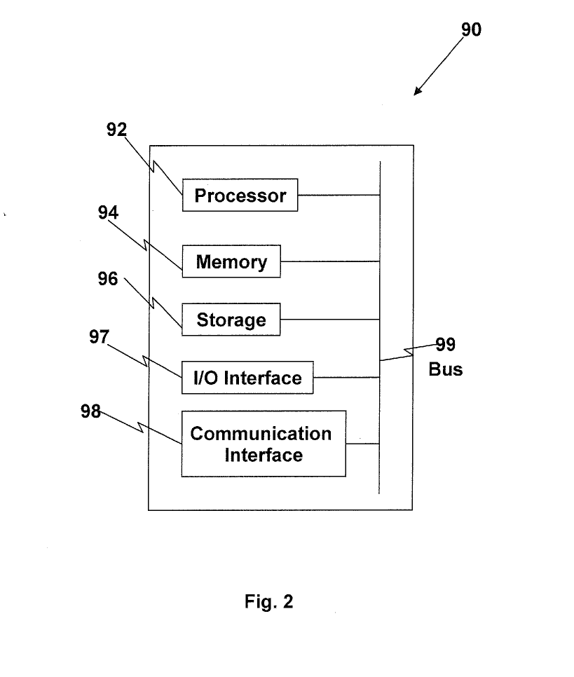

FIG. 2 is an example computer system 90 of the present invention. Software running on one or more computer systems 90 can provide the functionality described herein and perform the methods and steps described and illustrated herein, at different times and or different locations. Computer system 90 may be distributed, spanning multiple locations, span multiple data centers, and reside in a cloud, which may include one or more cloud components in numerous networks. Example computer system 90 in certain embodiments may include one or more of the following arranged in any suitable configuration: a processor 92, memory 94, storage 96, input/output (I/O) interface 97, communication interface 98, and a bus 99. Computer system 90 may be a server, a desktop computer, a laptop computer, a tablet computer, a mobile phone, or any combination of two or more of these physical embodiments. Processor 92, memory 94, storage 96, input/output (I/O) interface 97, communication interface, and a bus 99, are all well known in the art as constituent parts of a computer system. In all embodiments computer system 90 implements a software application comprising a computer-readable medium containing computer program code, which can be executed by processor 92 for performing any or all of the steps and functionality of system 10 of the present invention.

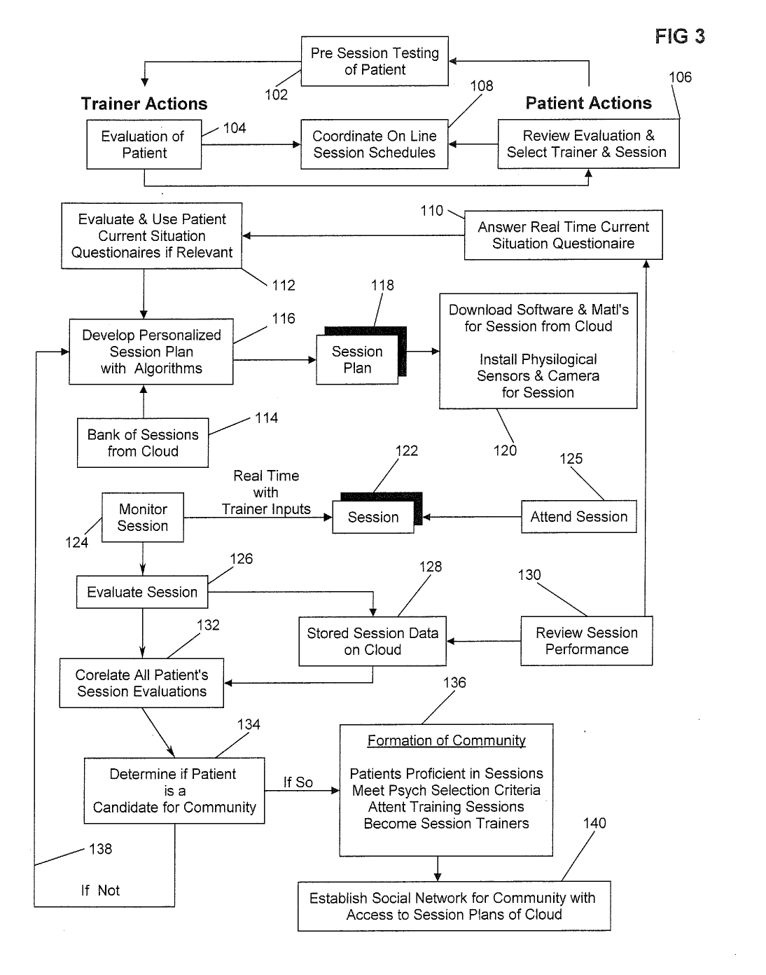

The steps of the general methodology of the BRMP system are shown in FIG. 3. A patient initially undergoes pre session cognitive testing 102 in order to formulate a profile that accurately depicts his or her needs. This testing data is accessed remotely by the trainer and used by the trainer for the initial patient evaluation 104. This evaluation is then placed back into network accessible data files that the patient is then able to view from his remote access mobile personal computing device 106 prior to the establishment of an appointment 108. The setting of an appointment begins with the trainers providing a list of their available times and locations for appointments. The patient can then select on line which trainer and appointment time best suits them. Once a patient chooses a trainer, the patient is required to provide and upload relevant personal information that is derived from the Current Situation Questionnaire 110. This questionnaire is completed each time before a session is conducted and asks basic mood and stress questions such as, but not limited to, the following:
Hours of sleep last night
Quality of sleep
Stress level
Anger level
Happiness index
Consumption of alcohol
Consumption of recreational drugs
   At this point, the selected trainer is able to view the patient's personal information 110 as well as the initial profile provided by the patient 102. The trainer may or may not use this data (depending on its relevance) 112 in conjunction with the accessible bank of existing session plans 114, to formulate a personalized, optimized session plan 116, using his personal expertise to determine the individual needs of that patient. Additionally, with direct communication between the patient and trainer already established (in the scheduling phase) the patient is able to communicate directly with the trainer in order to provide input in order to assist the trainer in creating an optimized personal session plan. With the patient's consent, the trainer is able to obtain information relating to the patient's medical history such as disorders and/or episodes that the patient is undergoing at the time. This allows the trainer to formulate an accurate medical profile of the patient.

The trainer hosts the session with the patient through the mobile platform. The session itself 122 is attended generally by a trainer and a patient, multiple patients without a trainer, or a trainer with multiple patients. (The actual exercises administered by the trainer in the sessions as well as the session protocol is discussed hereafter.) The personal session plan 118 is stored so as to be accessible to the patient and trainer simultaneously. The patient downloads required software and materials for the session 122 directly to his personal mobile computing device 120. End user machines such as tablet computers allow the trainer and the patient to establish AN telepresence in order to maximize the effectiveness of exercises during sessions as well as to streamline communication between the parties.

Depending on the specific situation, it may be desirable to monitor a variety of other patient parameters during the session exercises, that may not be directly measured by the trainer such as heart rate and blood pressure. These parameters complement factors such as time delays and response accuracy that are measured by the trainer. These patient parameters measurements are taken by physiologic sensors integrated into the system or from available third party sensors.

Following the conclusion of the session 122, the trainer generates a post session performance analysis 126 for the patient utilizing the results of the session. The analysis is uploaded to the cloud 128 where the patient is able to access the report 130. The stored performance analyses allows the trainer to analyze patient performance after correlating all the data from previous sessions 132. System 10 has the ability to automatically score patient performance in detail, including error rate, time between responses, type of error, etc. This automatic scoring is possible, because the trainer through standard rule manipulation can adjust each exercise. Automatic scoring has the additional benefit of reducing trainer mental burden, providing a second “check” to ensure scoring accuracy, assembling a patient performance database (enabling detailed analysis of client performance), and additionally enabling community training with a scoring system that is unbiased and accurate. These analyses allow the trainer to determine if the patient is a both a good candidate and is ready for inclusion into the “community” 134. If not, the cycle repeats itself with further cycles of cognitive training 138. Each session again is personally developed looking at that patient's progress and current situation questionnaire plus any additional information the patient wishes to share with the trainer.

Once enough like patients have been assembled into a working group, a “community” is formed 136. The individual patient members of the “community” now undergo training to themselves become session trainers. There is a social network established for the “community” 140 wherein they may access limited portions of the BRMP system limited to what is needed to create new sessions. From this point on the patients in the “community” may participate in role playing games in pairs or groups wherein some function as trainers and some function as patients, following the BRMP steps 110 to 132 as outlined above.

The BRMP sessions derive their effectiveness through both the use of the technology as well as the personalization of the session plans. The technology of the end user machines are utilized in facilitating communication between trainers and patients through audio/video (A/V) channels. This allows trainers and patients to establish telepresence during sessions to closely simulate direct person to person interactions. Additional technology of the end user machines allow increased functionality in terms of interactivity. Technologies such as touch screen interaction, voice recognition, and haptic feedback may be incorporated into sessions to improve interactivity between trainers and patients. The system may include virtual reality interfaces.

The system is able to incorporate and effectively utilize physical games and objects at the user end. The telepresence tools of the present invention allow the interaction between the games and objects and the user to be more productive and efficient. This is because the trainer may observe and guide the user in interacting with the physical object as if he or she is physically standing beside the patient/trainee/patient. The aforementioned features are readily accessible through the trainer and patient GUIs. In order to maximize accessibility, numerous GUI characteristics are customizable including, but not limited to, font sizes/colors/styles, brightness, and contrast.

Exercises for the sessions are generally designed to facilitate brain rehabilitation and cognitive enhancement and include, but are not limited to:
Standard Brain Rehabilitation and Cognitive Enhancement Exercises
Number matching
Word searches
Categorization/organization activities
Number sequences/patterns
Rhythmic matching
Third party games available to access via a web browser

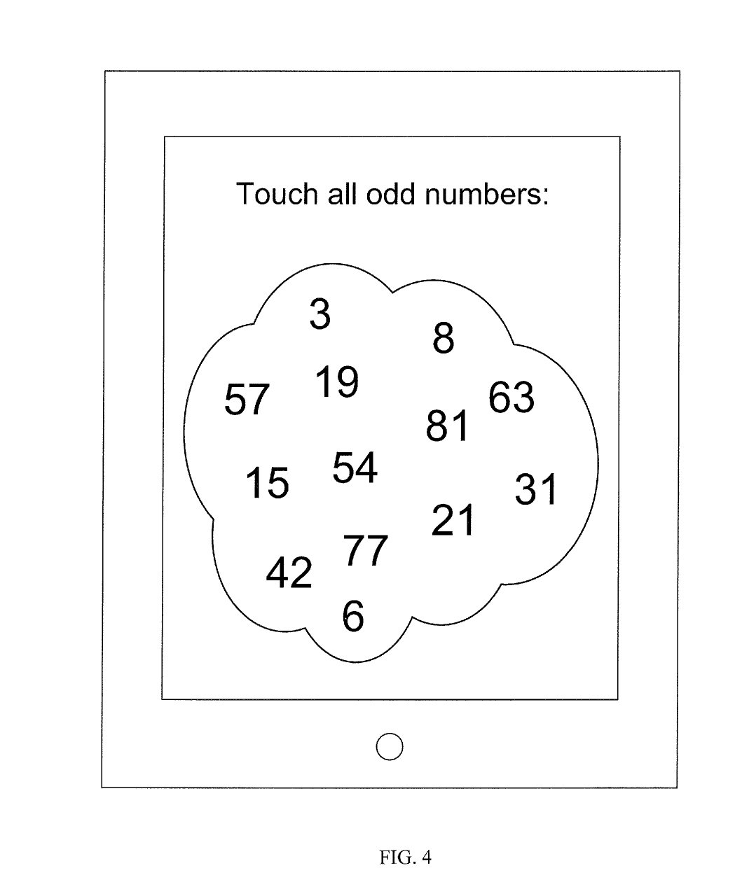

Third party games are accessed via a user account attached to the patient account in order to keep track of the patient's progress in these games as well. For example, the patient may register on the mobile platform of the present invention using his or her existing social media accounts. These exercises are chosen and administered by trainers to patients directly through the GUIs of the end user machines. Trainers are able to manage and regulate the auditory and visual content that is displayed to patients through the patients' GUIs. In many cases, these exercises are facilitated by technology such as touch screen technology. An example exercise is shown in FIG. 4. As patients participate in these exercises, the patients' reactions, responses, and overall progress in the rehabilitation process are stored including those optionally gathered by direct means of detection such as voice recognition, image recognition, blood pressure, and heart rate. The data may be gathered by the trainer through indirect means as well. For example, the trainer may register qualitative and quantitative data regarding patient reactions, responses, and progress.

When sessions are conducted with the optional sensors, the system collects physiologic data through the patient tablet by wireless sensors that record body temperature, oximetry, pulse rate, respiratory rate, and blood pressure and skin conductance. Many of these sensors are commercially available and integrate either by a wireless or Bluetooth or even wired methods into this system through the patients tablet computer. Camera on the tablet can also measure anxiety through activity and squirm of the patient as well as facial expression recognition cues. This data streams into the overall system to create the physiologic database for each cognitive exercise performed.

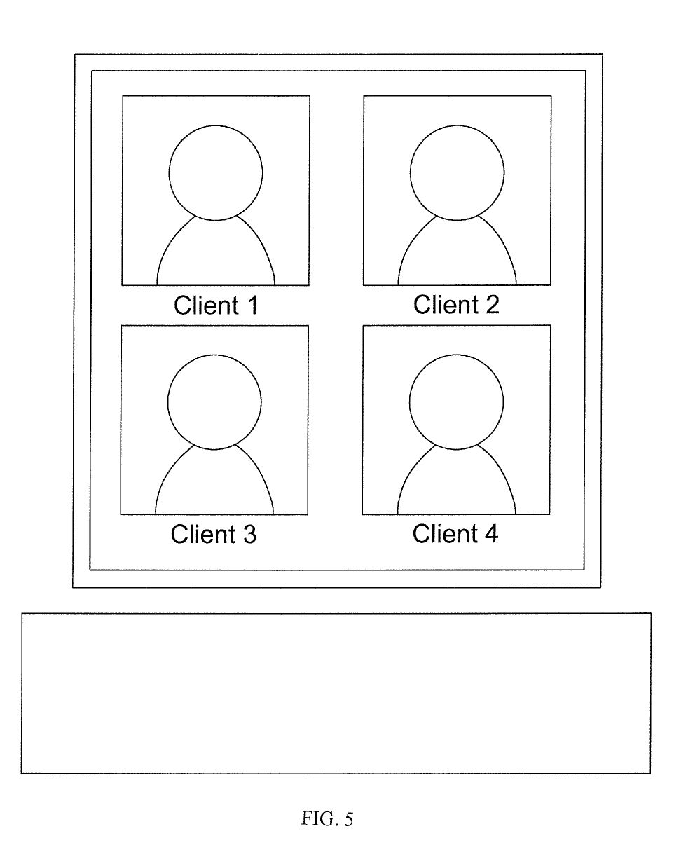

A trainer is able to host sessions with multiple patients simultaneously as shown in FIG. 5. Telepresence is established in order to allow A/V communication among the patients as well as with the trainer.

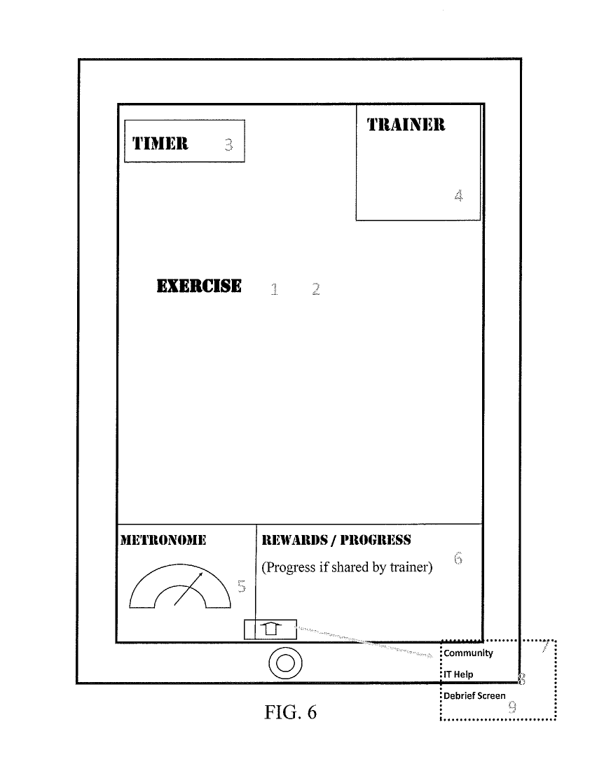

The BRMP system features a scoring system that complements the performance analysis conducted by the trainer. For example, the scoring system may take into account a variety of factors that may not be directly measured by the trainer such as heart rate and blood pressure level during exercises. These factors complement factors such as time delays and response accuracy that are measured by the trainer. These measurements are taken by physiologic sensors integrated into the system or from available third party sensors. The data from the current exercise event can then be correlated to the patient's prior performance data to create graphs and charts that make performance changes over time apparent. Performance and individual exercises can then be correlated with performance on standardized cognitive testing instruments such as Woodcock Johnson battery, the NIH brain toolkit, etc. The summary and specific data can be shared with the patient via a patient debriefing feature and integrated into a trainer's notebook for future exercise planning file. This is illustrated in the screenshot of FIG. 6. During a session, while the exercise is being delivered to a patient, the trainer may record his comments in the notebook module of the BRMP system.)

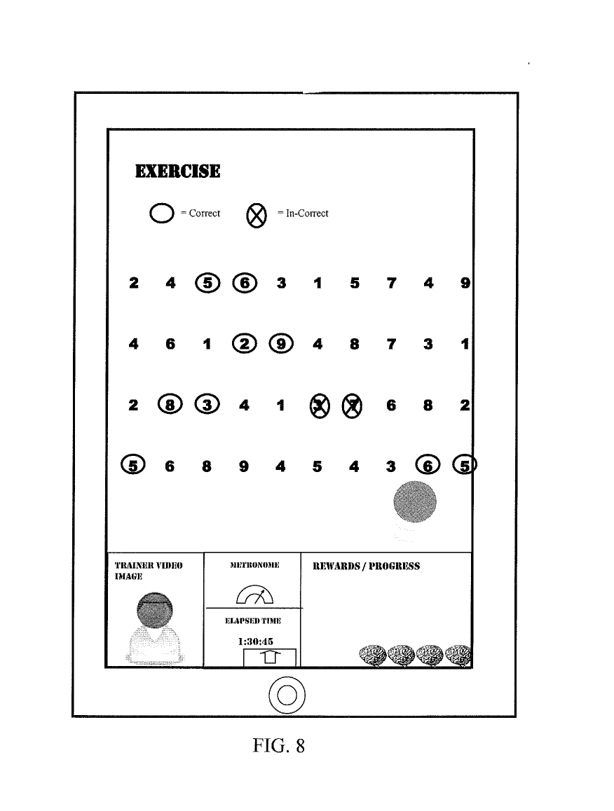

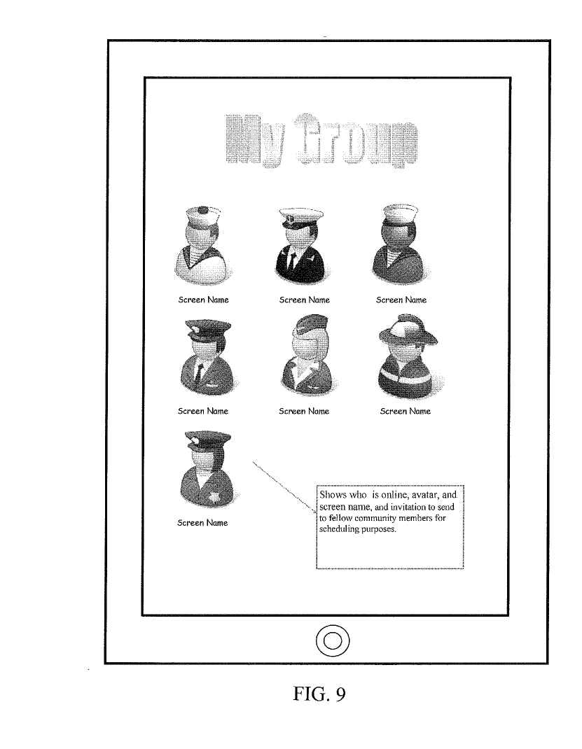

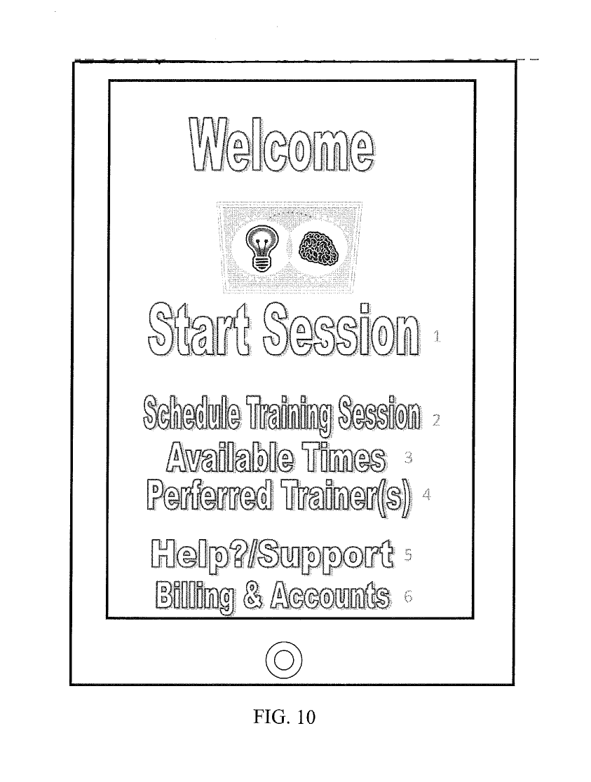

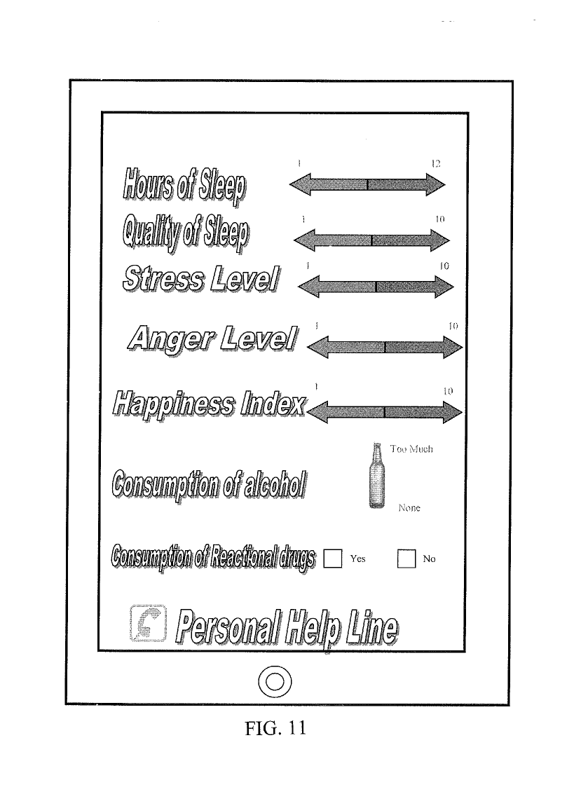

The ease of operation and clarity of use for the patient is of the utmost importance. For this reason the patient's screen displayed on their GUI is designed to incorporate the following: (Screenshots illustrated in FIGS. 6, 8-11)

1. Graphics for the cognitive exercise being delivered. The graphic display is sized with the degree of video definition that would be easy-to-read on the typical tablet or laptop. (Hi definition and color graphics are preferred embodiments) The graphic presentation could be magnified for the visually impaired.

2. Optional included distractions designed to make the exercise more difficult and demanding of more attention. Such examples would be video bugs crawling across the screen, bouncing balls, and flashing lights. Audio distractions can also be incorporated separately or in conjunction with video distractions. Examples could be background static, voices talking, music etc.

3. An elapsed specific exercise and elapsed total session times box that can be placed on the patient screen at the discretion of the trainer.

4. A real time video feed of the trainer's image not so large as to overwhelm the other components of the display in normal operation but large enough with sufficient clarity that the facial expressions and gestures of the trainer are transmitted to create telepresence. Upon trainer command, the image of the trainer can increase in size to become the dominant image on the screen as a feature to grab the patient's attention. At that point, the volume can be adjusted accordingly to keep the training focused on the message. The position and size of the trainer video image is adjustable and sizeable.

5. Timing metronomes in both visual and auditory formats. The metronome auditory and visual signal is synchronized so that it occurs appropriately on the patient's display for queuing and displayed appropriately on the trainers side to determine if the patient's response follows the metronome cue.

6. A progress bulletin board to show performance speed accuracy on the various parameters of the exercise. The electronic oversight feature allows collection of data in fine granularity. Example data points would be the number correct and percentage of correct responses, time interval between responses, time in between correct versus erroneous responses, physiologic state during the exercise and at the time of response. This data would be collected on every exercise and every session, building a master performance database from which comparisons, correlations and trends can be elucidated to be presented in tables, and graphs.

7. A role selection toggle for community use so that an individual knows whether they're functioning as a trainer or patient.

8. An “IT HELP” feature that allows immediate access to IT support services in order to fix any software problem encountered during the session.

9. A patient debriefing feature that enables the trainer to share information from various screens on their side and construct a performance debriefing based on detailed data, both automatically and trainer generated. This screen can be expanded and moved as needed by the trainer.

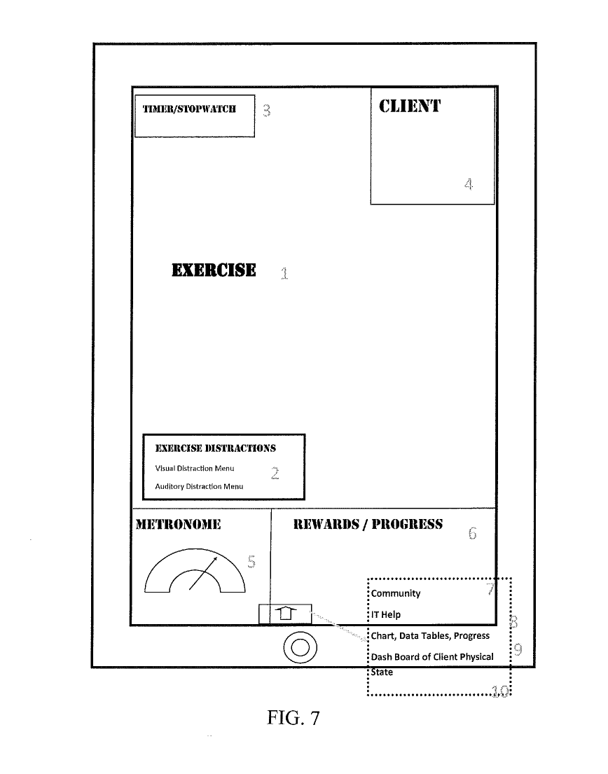

Similarly, because the patients may also become trainers for their ease of operation and clarity the trainer's screen displayed on their GUI is designed to incorporate the following: (Screenshot illustrated in FIG. 7)

1. Graphics for the cognitive exercise being delivered. The graphic display is sized and degree of video definition that would be easy-to-read on the typical tablet or laptop. (Hi-definition and color graphics are preferred embodiments) The graphic presentation could be magnified for the visually impaired.

2. Trainer introduced exercise graphical distractions designed to make the exercise more difficult and demanding of more attention. Such examples would be video bugs crawling across the screen, bouncing balls, and flashing lights. Audio distractions can also be incorporated separately or in conjunction with video distractions. Examples could be background static, voices talking, music etc. The trainer has a panel that includes a menu of many different audio and video distractions to be introduced into the training session.

3. A basic stopwatch function to time the exercise and can share that elapsed time with the patient.

4. A real time video feed of the patient image not so large overwhelm the other components of the display in normal operation. The position and size of the patient video image is adjustable and sizeable.

5. A timing metronome available in both visual and auditory formats. The metronome auditory and visual signal is synchronized so that it occurs appropriately on the trainees display for queuing and displayed appropriately on the trainers side to determine if the trainees response follows the metronome cue. The pace, character, volume and tone character set by the trainer at their metronome panel. The trainer also may play a visual metronome on the trainees screen for patients who have hearing impairment. The metronome can also have a vibratory feature on the patient's tablet as an alternative.

6. A progress board that the trainer can elect to share, showing speed and accuracy results on the various parameters of the exercise. A reward icon(s) can also be projected (typically a gold glowing brain outline) onto the patient's workspace. Such a reward icon can also be automatically generated when the machine scoring tabulates so many correct answers, within time goals, or other parameters indicating patient progress according to a predetermined rewards formula.

7. A role selection toggle for community use so that an individual knows whether they're functioning as a trainer or training Such a feature allows quality assurance or other individuals to observe the training session.

8. An IT HELP feature.

A database of finely granulated performance and physiologic measurements which may be developed by the system of automated machine processing. In most cognitive exercises, the correct answers can be machine determined and compared to patient responses. The predetermined correct answers could be readily changed to adapt to trainer commands. An example exercise features rapid arithmetic and mental number manipulation in which the trainer presents a screen array of random numbers and asks the patient to identify each adjacent numbers in that when added together equals 11. The machine algorithm for the exercise and corresponding to trainer specified set instructions identifies these pairs instantly. The machine identified correct numbers could appear highlighted in green on the trainer screen, thereby easing the trainer's cognitive burden and freeing up the trainer's analytic faculties. When the patient taps or utters their selections, the correct and erroneous answers are made apparent by comparing the response to the correct answer sheet. The correct responses and errors then can be catalogued and tagged with response times, speech characteristics and patient physiologic data. Cataloging the patient's total response in fine granularity and in real time assembles robust little physiologic and psychological databank (based on patient self reported mood, sleep patterns, & stress/anxiety levels) for the trainer modify exercise intensity and content as well as hard data for further analysis overall program improvement.

9. A dashboard of patient's physiological state such as pulse rate, skin conductance. This can be opened, closed, sized and positioned on the trainer's workspace as desired.

The system allows individual patients to conduct brain-training exercises among themselves without formalized trainer oversight after these patients meet proficiency and psychological selection criteria in order to create a community. The individual patients demonstrate an understanding of the cognitive training system, coaching methods and philosophy. They must have proven maturity and psychological stability as judged by their individual trainers and program testing of cognitive abilities and psychological mood and personality. In the current program the Woodcock Johnson Battery, The NIH Brain Toolkit, the Becks Depression Index and numerous other tests provide objective evidence in support of this trainer decision. After screening by the trainers, the individual is taught how to use the control features of the trainer's screen. The individual participates in a preceptered training session(s) functioning as a trainer. When the individual has demonstrated skill and aptitude they are then enrolled into the brain training community. They select an avatar and a moniker as per program policy.

Approved community brain training patients (ACBTC) can sign in to the community and schedule a session with another ACBTC or link up immediately with an available individual under group bulletin board. Once an invitation is accepted the two individuals choose roles and begin training All the features of the system are at their disposal. The system is designed to keep personal and medical information confidential

Patient and trainers have logon screens to facilitate their connection and creation of an AV channel supported by all the features described in the program. First the individual logs in with their username and password or biometric identifier. They may choose to:

1. “Start a session” that has been previously scheduled and approved

2. “Schedule a training session” enables the patient to reach out to other ACBTC and set a date in time two meet in order to train together

3. “Available times” enables the patient to post their availability on the bulletin board to solicit others to schedule a training date

4. Preferred trainers enables the patient to reach out and schedule a training date with the individuals they prefer.

5. IT help provides access two supporting IT professionals via through live chat, text, VOIP and other messaging modalities.

6. “Billing and accounts” provides access to the program's billing department and business administration. The portal into the billing system, features the ability to pay bills, manage insurance coverage and talk to the billing department. The billing department can be accessed through live chat, text, VOIP and other messaging modalitie

In summary, the overarching goal of the BRMP is to improve and optimize brain rehabilitation and cognitive enhancement by strengthening the human interaction involved in conducting cognitive exercises. By emphasizing communication, the mobile platform facilitates the ability for trainers to accurately identify and appropriately address patient needs. The present invention offers the benefits of direct person to person interactions on a remote platform. The optimized communication channels of the mobile platform facilitate creating and fostering a community of users as well.

This cognitive training platform is not to be limited to brain injury applications as there are numerous other applications such as dementia or any reason for enhanced performance in the normal brain. There is a need for a complete office package (scheduling, training records keeping, billing etc.) to be provided to occupational therapists, neurologic psychologists, psychological trainers and other professionals who want to enter the telemedicine delivery of their services. The need for occupational therapy in schools cannot be met reasonably without telemedicine. Telemedicine seeks to improve a patient's health via exchanging medical information from one location to another through electronic communication, and can include the exchange of information through smart phones, tablet computers, two-way video, or any form of telecommunication technology. The independent therapist requires a platform and complete business system to enter this arena, such as the present invention provides.

Although the present invention has been explained in relation to its preferred embodiment, it is understood that many other possible modifications and variations can be made without departing from the spirit and scope of the present invention.

I claim:

1. A method of telemedicine delivery of brain rehabilitative therapy and cognitive enhancement services via a distributed network, comprising the steps of:
Step 1—conducting a computerized pre-session testing of a patient, wherein a set of responses to said pre-session testing is stored and available for review;
Step 2—assembling a listing of available trainers and available session times accessible to said patient;
Step 3—reviewing and evaluating of said set of responses to said pre-session testing by a trainer to develop a pre-session evaluation, wherein said pre-session evaluation is accessible to said patient;
Step 4—reviewing said pre-session evaluation and selection of a trainer and session time by said patient;
Step 5—establishing communication between a selected trainer and said patient;
Step 6—coordinating a schedule of said trainer with a schedule of said patient for future sessions over said distributed network;
Step 7—developing a personalized session by said selected trainer based on said pre-session evaluation and from a set of session exercises obtained from a bank of session exercises;
Step 8—storing said session so as to be accessible to said patient;
Step 9—acquiring of any applications or data as required by said session;
Step 10—participating in said session by said patient and said selected trainer;
Step 11—evaluating said session by said selected trainer when said session is completed to compile a session evaluation and storing said session evaluation so as to be accessible to said patient;
Step 12—reviewing said session evaluation by said patient and communicating said comments to said selected trainer prior to next said session development.

2. The method of telemedicine delivery of brain rehabilitative therapy and cognitive enhancement services via a distributed network of claim 1 further comprising the steps of:
completing a real time current situation questionnaire by said patient which is accessible to said selected trainer prior to said developing a personalized session by said selected trainer;
developing said personalized session by said selected trainer also based on said current situation questionnaire.

3. The method of telemedicine delivery of brain rehabilitative therapy and cognitive enhancement services via a distributed network of claim 2 further comprising the step of:
installing physiological sensors and video cameras capable of transmission of signal over said distributed network as required by said session prior to the participating in said session.

4. The method of telemedicine delivery of brain rehabilitative therapy and cognitive enhancement services via a distributed network of claim 3 further comprising the steps of:
correlating all said patient's said session evaluations by said selected trainer prior to next said session development;
determining if said patient is a candidate for inclusion into a distributed network community for brain rehabilitative therapy and cognitive enhancement services;
participating in at least one additional session following steps 6 to 12, wherein said patient is not a candidate for inclusion into a distributed network community for brain rehabilitative therapy and cognitive enhancement services.

5. The method of telemedicine delivery of brain rehabilitative therapy and cognitive enhancement services via a distributed network of claim 4 further comprising the steps of:
training of patients selected as said candidate for inclusion in said distributed network community for brain rehabilitative therapy and cognitive enhancement services;
establishing a social network for a group of patients included in said distributed network community wherein access to said set of session exercises is granted to said group of patients in said community.

6. The method of telemedicine delivery of brain rehabilitative therapy and cognitive enhancement services via a distributed network of claim 5 further comprising the steps of:
having at least two patients from said group of patients included in said distributed network community determine their respective role of trainer or patient; and
participating in at least one session following steps 6 to 12.

7. A method of telemedicine delivery of brain rehabilitative therapy and cognitive enhancement services comprising the steps of:
Step 1—conducting a computerized pre-session testing of a patient, via a distributed network wherein a set of responses to said pre-session testing is stored and available for review on said distributed network;
Step 2—assembling a listing of available trainers and available session times which is stored on said distributed network and accessible to said patient;
Step 3—reviewing and evaluating of said set of responses to said pre-session testing by a trainer to develop a pre-session evaluation, wherein said pre-session evaluation is stored on said distributed network and accessible to said patient;
Step 4—reviewing said pre-session evaluation and selection of a trainer and session time by said patient;
Step 5—establishing distributed network communication between a selected trainer and said patient;
Step 6—coordinating a schedule of said trainer with a schedule of said patient for future sessions over said distributed network;
Step 7—completing a real time current situation questionnaire by said patient which is stored on said distributed network and accessible to said selected trainer;
Step 8—developing a personalized session by said selected trainer based on said pre-session evaluation, said current situation questionnaire and from a set of session exercises obtained from said distributing network,
Step 9—placing said session on said distributed network so as to be accessible to said patient;
Step 10—acquiring of any applications or data from said distributed network as required by said session;
Step 11—installing physiological sensors and video cameras capable of transmission of signal over said distributed network as required by said session;
Step 12—participating via said distributed network, in said session by said patient and said selected trainer;
Step 13—evaluating said session by said selected trainer when said session completed to compile a session evaluation and storing said session evaluation on said distributing network so as to be accessible to said patient;
Step 14—reviewing said session evaluation by said patient and communicating said comments to said selected trainer prior to next said session development;
Step 15—correlating all said patient's said session evaluations by said selected trainer;
Step 16—determining if said patient is a candidate for inclusion into a distributed network community for brain rehabilitative therapy and cognitive enhancement services;
Step 17—participating in at least one additional session following steps 6 to 13, wherein said patient is not a candidate for inclusion into a distributed network community for brain rehabilitative therapy and cognitive enhancement services;
Step 18—training of patients selected as said candidate for inclusion in said distributed network community for brain rehabilitative therapy and cognitive enhancement services;
Step 19—establishing a social network for a group of patients included in said distributed network community wherein access to said set of session exercises from said distributing network is granted to said group of patients in said community;
Step 20—having at least two patients from said group of patients included in said distributed network community determine their respective role of trainer or patient; and
Step 21—participating in at least one session following steps 6 to 15.
